(19) United States
(12) Patent Application Publication
(10) Pub. No.: US 2026/0336832 A1
(43) Pub. Date: Oct. 29, 2026

(54) Photophoretically Levitating Macroscopic Structures

(71) Applicant: President and Fellows of Harvard College, Cambridge, MA (US)

(72) Inventors: Benjamin C. Schafer, Albuquerque, NM (US); David W. Keith, Cambridge, MA (US); Joost J. Vlassak, Lexington, MA (US); Jong-hyoung Kim, Cambridge, MA (US)

(21) Appl. No.: 18/995,663

(22) PCT Filed: Jul. 21, 2023
(86) PCT No.: PCT/US2023/070703

§ 371 Date: Jan. 16, 2025

Related U.S. Application Data
(60) Provisional application No. 63/391,159, filed on Jul. 21, 2022.

(51) Int. Cl. B64G 1/24; B64C 19/00

(52) U.S. Cl. CPC B64G 1/244; B64C 19/00

(57) ABSTRACT

A photophoretically levitating macroscopic structure includes a photophoretically active structure (PAS), a PAS support framework, and a device superstructure. The photophoretically active structure includes at least one top sheet and at least one bottom sheet. The bottom sheet has greater solar-radiation absorptivity than the top surface, and each sheet defines a pattern of holes through which gas can flow. The sheets are separated by a gap that defines an open volume extending across a plurality of holes in each sheet. The photophoretically active structure is mounted in or on the PAS support framework. The device superstructure is mounted to and spans the PAS support framework to increase the rigidity of the photophoretically levitating macroscopic structure.

### GOVERNMENT SUPPORT

This invention was made with government support under Grant No. 2011754 awarded by the National Science Foundation. The US Government has certain rights in this invention.

### BACKGROUND

The discussion of the background state of the art, below, may reflect hindsight gained from the disclosed invention(s); and these characterizations are not necessarily admitted to be prior art.

As previously suggested by co-inventor David W. Keith, microscale, engineered particles could be used as geoengineering aerosols to mitigate risks posed by the accumulation of greenhouse gases. Keith, D. W., “Photophoretic Levitation of Engineered Aerosols for Geoengineering,” 107 Proceedings of the National Academy of Sciences 38, 16428-16431 (2010) (“Keith”). Therein, he outlined how bilayer particles of thickness and radius of order 100 nm and 10 μm, respectively, could levitate at the stratopause and mesopause due to a force (Aa photophoresis) caused by an asymmetry in the thermal accommodation coefficients, a, of the particles' top and bottom surfaces. The particles would settle slowly enough in the absence of sunlight to remain lofted indefinitely. Keith also outlined a mechanism for aligning the photophoretic force vector upward using internal gravitational, electric, or magnetic torques.

Recently, the Bargatin group published papers presenting photophoretically active structures roughly 103 times larger than those proposed by Keith. Azadi, M., et al., “Controlled Photophoretic Levitation of Nanostructured Thin Films for Near-Space Flight,” arXiv:2005.06493 [physics] (2020), and Cortes, J., et al., “Photophoretic Levitation of Macroscopic Nanocardboard Plates,” 32 Advanced Materials 1906878 (2020). In the first paper from this group, Azadi, et al., experimentally verified Δα photophoretic forces capable of levitating 0.6-cm-diameter Mylar disks under mesospheric pressures and the illumination of several suns from below. In the second of the above-listed papers, Cortes, et al., fabricated hollow alumina structures of the order of 1-cm wide, of the order of 100-μm thick, and with an areal density of 1 g/m², termed “nanocardboard,” that develop internal temperature gradients when illuminated. These gradients generate upward thrust via thermal transpiration, or thermal “creep” flow, through vertical channels spaced periodically throughout the structures. Bargatin's group successfully levitated nanocardboard under stratospheric pressures and the illumination of several suns from below. By exploiting thermal transpiration instead of Δα photophoresis, nanocardboard-like structures generate much larger total upward forces than the structures of Keith and Azadi, which only generated significant forces when they have a horizontal dimension smaller than the mean free path (MFP) of the surrounding gas.

### SUMMARY

Photophoretically levitating macroscopic structures and methods for their use are described herein, where various embodiments of the structures and methods may include some or all of the elements, features, and steps described below.

A photophoretically levitating macroscopic structure comprises a photophoretically active structure (PAS), comprising at least one top sheet and at least one bottom sheet, wherein the bottom sheet has greater solar-radiation absorptivity than the top surface, wherein each sheet defines a pattern of holes through which gas can flow, wherein the sheets are separated by a gap that defines an open volume extending across a plurality of holes in each sheet; a PAS support framework in which or on which the photophoretically active structure is mounted; and a device superstructure mounted to and spanning the PAS support framework to increase the rigidity of the photophoretically levitating macroscopic structure. The macroscopic structure is photophoretically levitated by delivering the photophoretically levitating macroscopic structure to a layer in an atmosphere about a celestial body (e.g., the earth). Solar radiation is preferentially received on the bottom sheet to heat the bottom sheet to a higher temperature than the top sheet. Heat is transferred from the bottom sheet to air from the atmosphere to warm the air below the photophoretically active structure to a higher temperature than the air above the photophoretically active structure. Air flow from above the top sheet is generated via thermal transpiration through holes in the top sheet, into the gap, and out holes in the bottom sheet. The macroscopic structure is levitated in the atmospheric layer via upward force generated by the thermal transpiration.

Photophoretic forces could levitate thin structures with a diameter of about 10 cm in the Earth's mesosphere or stratosphere indefinitely.

In the following text, we examine the feasibility of levitating macroscale structures in the stratosphere (at an elevation of 20-50 km from the surface of the earth) or mesosphere (at an elevation of 50-100 km from the surface of the earth) via thermal transpiration. Such structures may be used as a new category of devices that can fly in the upper atmosphere with payloads of hundreds of milligrams and without propulsion equipment. Since levitation can be passively achieved solely as a result of the structure's design and materials, onboard power may be incorporated only for motion control and any applications for which the structures are deployed. Communication between a lofted photophoretically levitating macroscopic structure and structures from the ground can expand capabilities for, e.g., in-situ atmospheric sensing (e.g., for climate research), remote measurements, and telecommunications to include microscale technologies that may complement existing aircraft and balloons. The photophoretically levitating macroscopic structure can be employed in the atmosphere of earth or in the atmosphere of other planets, such as Mars.

The physics of thermal transpiration are first discussed with a description of a minimal structure to achieve levitation. Next, analytical models are presented that calculate the levitating force on this structure with specified radiative, thermal, and design parameters at a given altitude with typical equatorial radiative forcing. After reporting the optimal parameters for maximized lofting force, we propose a practical structure that could be fabricated in a relatively short time period. The middle stratosphere is a good environment for levitation due to its minimal turbulence and slow settling velocity (on the order of 1 cm/s) for centimeter-scale thin plates weighing hundreds of mg. Nevertheless, lofting forces due to thermal transpiration are generally higher in the mesosphere, where there is also less turbulence but where settling velocities are faster (on the order of 10 m/s). An exemplary disk-shaped structure proposed herein has a 10-cm diameter and can levitate stably at an altitude of 70 km above the earth, lofting a total mass of around 75 mg. Additionally, methods for motion control, attitude adjustment, and deployment are discussed. Finally, onboard technology to enable communication with the ground or nearby balloons and associated applications are discussed.

Our modelling shows that a structure with an optimized lofting force can include a radiatively cooling top sheet and radiatively warming bottom sheet separated by an air gap equal to the mean free path (MFP) and with about half of the sheets' faces being holes with radii smaller than the MFP. This practical structure can have a diameter of 10 cm with a diurnally averaged payload capacity of 40 mg at a stable altitude of 75 km. The thermal gradient is provided by a solar-transmissive, infrared-emissive top sheet and a solar-absorptive, infrared-transmissive bottom sheet. We describe the possibility of communication with ground-based optical transmitters. Further, the structure can levitate indefinitely in the atmosphere solely via the photophoretic force, can control its own motion, and can be sufficiently strong to withstand forces that may be encountered in transport, deployment, and flight. These features can make the photophoretically levitating macroscopic structure valuable in a range of atmospheric applications or telecommunications. Larger structures may have payloads of a few grams.

### BRIEF DESCRIPTION OF THE DRAWINGS

FIG. 1 illustrates Δα photophoresis produced by a difference in accommodation coefficient between the top and bottom sheets of a structure that is warmer than the surrounding gas.

FIG. 2 illustrates ΔT photophoresis produced by a difference in the temperatures of the top and bottom sheets.

FIG. 3 illustrates thermal transpiration through a structure resulting from a thermal gradient between regions of air above and below the structure, respectively.

FIG. 4 is a heat-resistivity diagram for photophoretically levitating macroscopic structure, showing heat transfer through a cross-section of the structure.

FIG. 5 is an image taken by a scanning electron microscope (SEM) of an example of a photophoretically active structure (PAS) including a top photophoretically active sheet and holes defined thereby as well as walls that form a PAS support framework.

FIG. 6 is another image taken by a scanning electron microscope (SEM) of an example of a photophoretically active structure (PAS) including a top photophoretically active sheet and holes defined thereby as well as walls that form a PAS support framework.

FIG. 7 includes plots from models of the following temperature, T, differences: T_{b}−Tₜ, T_{b,air}−T_{t,air}, where b and t respectively represent the bottom and top, and the diurnally averaged lofting force as the thermal boundary layer thickness, d, varies parametrically, with a structural height H=125 μm.

FIG. 8 includes plots showing diurnally averaged lofting forces vs. altitude for both H<<λ and H>>λ models, where λ is the mean free path (MFP) of the gas, for a structure of atomic-layer-deposited (ALD) alumina with thermal conductivity 1.8 Wm⁻¹K⁻¹, αₜ=α_{b}=0.6, H=125 μm, f=0.47, w=0, ϵₛₜ=ϵ_{lb}=0, ϵₗₜ=ϵ_{sb}=1, and a 10-cm disk diameter (set as d), where only the minimum of the two models at a given pressure is reported.

FIG. 9 includes plots for the structure of FIG. 8, showing diurnally averaged lofting forces vs. altitude for H=1000 μm, 300 μm, and 100 μm, and 30 μm.

FIG. 10 includes plots for the heat transfer terms of FIG. 4 vs. altitude for a structure with H=125 μm and otherwise that of FIG. 8, except where noted.

FIG. 11 includes plots of the ratio of energy flow through the top sheet to the bottom sheet in the H>>λ model for the structure of FIG. 8, except where noted.

FIG. 12 is a sectional view of a photophoretically active structure, including an I-beam-shaped interlayer scaffold formed of ALD alumina coated on its top surface with a top radiative-cooling coating with low solar-band emissivity and high thermal-band emissivity and coated on its bottom surface with a bottom coating with high solar-band absorptivity and high thermal-band transmissivity, wherein the interlayer scaffold and the coatings together form the photophoretically active structure.

FIG. 13 shows the domed horizontal cross section of a photophoretically levitating macroscopic structure where the photophoretically active structure and its support framework have an arched configuration.

FIG. 14 schematically illustrates a vertical cross-section of a photophoretically active structure (PAS) and its support framework.

FIG. 15 is a perspective view of a device superstructure in the form of a hexagonal ring along the outside of a PAS support framework.

FIG. 16 shows means for attitude adjustment of the photophoretically levitating macroscopic structure in the form of a payload attached to a rigid shaft and angled with a micro-electromechanical-system (MEMS) actuator attached to the bottom of the PAS support framework, wherein the MEMS actuator controls the attitude of the structure by adjusting the tilt angle of the rigid shaft.

FIG. 17 shows means for attitude adjustment of the photophoretically levitating macroscopic structure in the form of a sliding panel configured to slide across the photophoretically active structure with the same hole pattern as the photophoretically active structure such that the sliding panel can be positioned by one or more MEMS actuators to cover or uncover the holes of the photophoretically active structure to permit or prevent local thermal transpiration flow.

FIG. 18 shows how time-averaged insolation of the photophoretically active structure creates a restoring torque when a dome-shaped structure is tilted away from the horizontal.

FIG. 19 is a perspective view of a photophoretically levitating macroscopic structure, including a photophoretically active sheet supported by and joined with a PAS support framework.

FIG. 20 provides a perspective view of the photophoretically levitating structure from beneath the structure, showing the bottom sheet of the photophoretically active structure.

FIG. 21 provides a perspective view from inside a hexagonal cell of the photophoretically active structure and PAS support framework between the top sheet and the bottom sheet of the photophoretically active structure.

FIG. 22 is a perspective view of an exemplification of the PAS support framework.

FIG. 23 shows the photophoretically active structure supported by a device superstructure that is mounted to the PAS support framework and that provides the photophoretically levitating macroscopic structure with structural reinforcement and support to reduce the risk of a loss of structural integrity.

FIG. 24 provides a perspective view of the top and bottom sheets of the photophoretically active structure without the PAS support framework.

FIG. 25 is a plot of time-averaged lofting force versus hole filling fraction for the structure of FIG. 7 at 70 km.

FIG. 26 provides plots showing the lofting for the photophoretically levitating macroscopic structure of FIG. 8 as a function of altitude and accommodation coefficients of the top and bottom surfaces.

FIG. 27 is a plot of time-averaged lofting force versus wall filling fraction for the structure of FIG. 8 at 70 km.

FIG. 28 is a plot of the change in temperature, ΔT, divided by the maximum value of ΔT averaged over the horizontal area of one hexagonal PAS cell of the photophoretically levitating macroscopic structure of FIG. 8 as a function of its side length and the thickness of the photophoretically active sheet.

FIG. 29 is a perspective view of an exemplification of the PAS with cylindrical posts separating the top and bottom PAS sheets.

FIG. 30 is a bottom perspective view of a photophoretically levitating macroscopic structure showing on-board components for communications, including a solar cell, integrated circuitry on the underside of the solar cell, and an antenna mounted to the integrated circuitry and the PAS support framework.

In the accompanying drawings, like reference characters refer to the same or similar parts throughout the different views; and apostrophes are used to differentiate multiple instances of the same item or different embodiments of items sharing the same reference numeral. The drawings are not necessarily to scale; instead, an emphasis is placed upon illustrating particular principles in the exemplifications discussed below. For any drawings that include text (words, reference characters, and/or numbers), alternative versions of the drawings without the text are to be understood as being part of this disclosure; and formal replacement drawings without such text may be substituted therefor.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures and phenomena described below can occur at ambient pressure (e.g., about 50-120 kPa—for example, about 90-110 kPa) and temperature (e.g., −20 to 50 °C—for example, about 10-35 °C) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly. The term, “about,” can mean within +10% of the value recited. In addition, where a range of values is provided, each subrange and each individual value between the upper and lower ends of the range is contemplated and therefore disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as those introduced with the articles, “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

### DESCRIPTIONS OF SYMBOLS

Fₚ photophoretic lofting force per unit area; positive in the upward direction
T_{b}, Tₜ temperatures of the bottom (top) surface layers of the structure
T_{b,air}, T_{t,air} temperatures of the bottom (top) surface air layers of the structure
T_{bm}, Tₜₘ temperatures of the air layers above (below) the bottom (top) surface of the structure
RF_{b}, RFₜ net radiative heat flux on the bottom (top) of the structure
ρ_{b}, ρₜ bottom (top) surface air layer density: for bottom calculated as ρ_{b}=P/RT_{b,air}
v_{b}, vₜ bottom (top) mean molecular gas speed; for bottom calculated as v_{b}=\sqrt{2k_{b}T_{b,air}/(λm)}
α_{b}, αₜ bottom (top) surface thermal accommodation coefficient, assumed to be 0.7 for all calculations
f hole filling fraction (fraction of the total horizontal area of the structure that is holes)
w wall filling fraction (fraction of the total internal volume of the structure that is wall material, including posts)
H structure height (distance between top and bottom surfaces)
T ambient temperature
P ambient pressure
v ambient mean gas speed
d thermal boundary layer thickness
kₐᵢᵣ bulk thermal conductivity of air, 0.0284 W/(m·K)
kₘₐₜ thermal conductivity of the scaffold material, 1.8 W/(m·K) for ALD alumina
h_{b}, hₜ heat transfer coefficients in air (W m⁻²K⁻¹) from the bottom sheet to ambient, and from the top sheet to ambient, respectively
hₘ, h_{m,air} heat transfer coefficients between top and bottom sheets, and between surface air layers, respectively
λ mean free path
S(t) solar constant, 1366 W/m², weighted by a positive half-sine wave with 24 h period
A average terrestrial albedo, 0.3
ϵ_{vis,b}, ϵv_{is,t} solar band emissivity of bottom (top) sheet
ϵ_{IR,b}, ϵ_{IR,t} longwave (IR) band emissivity of the bottom (top) sheet of the structure
Tₑ terrestrial thermal upwelling blackbody temperature, 255 K
c_{P} heat capacity of air, 1000 J/(kg·K)
σ Stefan-Boltzmann constant, 5.67×10⁻⁸ W/(m²K⁴)
k_{B} Boltzmann constant, 1.38×10⁻²³ J/K
R ideal gas constant for dry air, 287.1 J/(kg·K)
m mean molecular mass of air, 4.81×10⁻²⁶ kg
δ thickness of PAS sheets

### How Thermal Transpiration Produces Thrust:

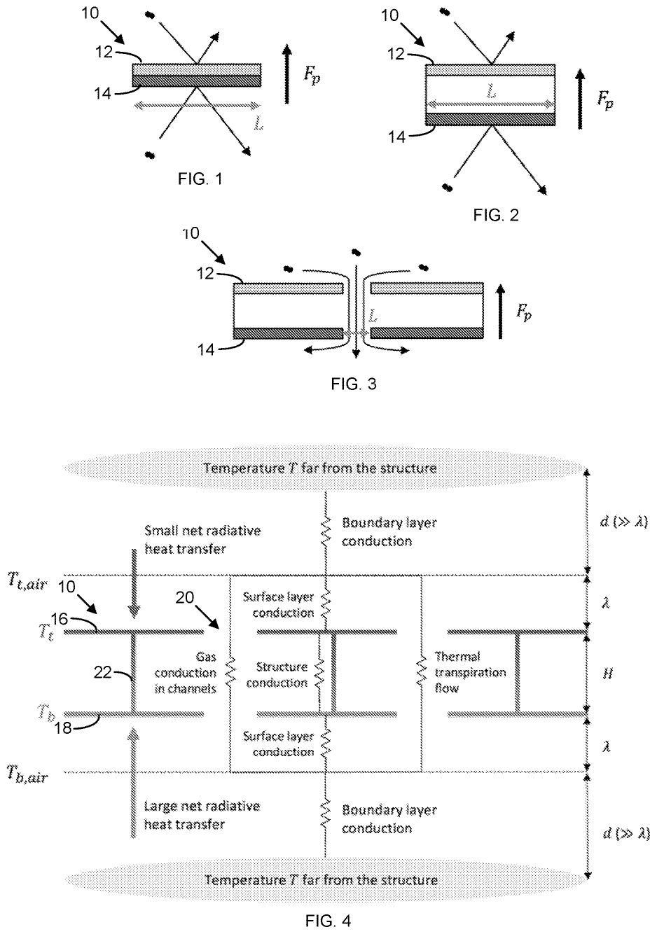

Radiative heat transfer induces thermal gradients within a structure and/or between a structure and its surroundings. These temperature gradients induce gas flows. The resulting photophoretic forces on a structure may be categorized into the following three distinct phenomena: (1) a difference in the thermal accommodation coefficient, a, over the surface of an isothermal structure with a temperature different from that of the ambient gas causes a net momentum transfer to the photophoretically levitating macroscopic structure 10, which includes a top photophoretically active sheet 12 with a low-α (and low-T) surface and a bottom photophoretically active sheet 14 with a high-α (and high-T) surface 14, via gas collisions (Δα photophoresis, FIG. 1); (2) a difference in the temperature over the surface of the structure also causes a net momentum transfer to the structure via gas collisions (ΔT photophoresis, FIG. 2); and (3) a thermal gradient between two regions of gas creates a flow from the cold region (above the photophoretically levitating macroscopic structure 10) to the hot region (below the photophoretically levitating macroscopic structure 10), which transfers momentum to a nearby structure (thermal transpiration, FIG. 3).

Photophoretic forces are significant when the gas flows that impart them are in the free-molecular (FM) regime, defined roughly as where the Knudsen number Kn(L)=λ/L is greater than 1, where λ is the mean free path (MFP) of the gas, and L is a characteristic length scale of the structure for a particular photophoretic mechanism. The length scale, L, for any given structure depends on the photophoretic mechanism in question. For instance, thin structures that could levitate via Δα and ΔT photophoresis have L equal to their smallest dimension normal to the force. The thin disks examined by Keith and Azadi, et al., which levitate via Δα photophoresis, had L equal to the diameters of the disks, thus limiting the levitation of macroscale disks to upper mesospheric pressures. The area and, therefore, lofting force, of similar isothermal structures can be increased by changing their shape. For instance, consider a thin isothermal structure in the shape of a cross with wings of width, L (as this is the characteristic length scale), and length, a, limited by the bending stiffness of the material. Assuming that the material is stiff enough such that L<<l, the payload capacity is roughly 4a/L times larger than a disk of radius, L, made of the same material. However, the structure design is still limited by the requirement, L≤λ.

Next, we consider an infinitely thin, nonconductive, horizontal plate surrounded by a gas of uniform pressure, P, that has different temperatures above and below the plate. The plate has periodically spaced holes with a filling fraction, f, and radii much smaller than λ (Kn>>1) so that any flow through the holes is rarefied. Some external heating transfer process ensures that the gas temperatures adjacent to the top and bottom of the plate are T_{t,air} and T_{b,air}, respectively.

Thermal transpiration flow through the holes (from the top to the bottom side of the structure) will create an upward force per unit area (i.e., a pressure) on the plate given by Fₚ, which can be defined as follows:

Fₚ=f(ρₜvₜ−ρ_{b}v_{b})²/ρ̅ (1)

where ρ=P/RTₐᵢᵣ is the air density; v=\sqrt{8k_{B}Tₐᵢᵣ/(πm)} is the average molecular speed; and the subscripts, t and b, denote the values on the top and bottom of the plate, respectively, where R is the ideal gas constant, k_{B} is the Boltzmann constant, and m is the average molecular mass of air. The two terms in the parentheses of Equation 1 are the mass air flows from the bottom to top regions and vice-versa, respectively, and ρ̅=(ρ_{b}+ρₜ)/2.

In the free atmosphere, the net flow exerts a pressure on the plate. If, instead, the plate divides two regions of fixed volume, one has a “Knudsen pump,” a device that produces an equilibrium pressure difference between the gas above and below the plate. The pressure difference between adjacent chambers in a Knudsen pump is proportional to Equation 1, with the proportionality determined by the shape of the barrier separating the chambers. F. Sharipov, “Non-Isothermal Gas Flow through Rectangular Microchannels.” 9 J. Micromech. Microeng. 394-401 (1999), found that rectangular channels connecting two chambers give pressure differences up to 80% of that in Equation 1.

### Modeling:

We next consider a structure that produces an upward thrust via thermal transpiration using one-dimensional (1D) analytical models that take the structure's design, radiative, and thermal parameters as inputs. FIG. 4 shows a vertical cross-section of the generalized structure 10 labeled with heat-resistivity terms. The structure 10 includes two horizontal photophoretically active sheets, top 12 and bottom 14, that are conceived as being infinitely thin and isothermal. Each defines periodically spaced holes 20 with radii smaller than λ so as to satisfy the free-molecular (FM) regime criteria. The top and bottom sheets 12 and 14 are separated by a series of thin walls (or posts) 22, which may be continuous or discontinuous, though the structure is mostly hollow. At a distance from the structure 10 equal to the thermal boundary layer thickness, d, we assume that the air has an ambient temperature, T. The distance, d, is many orders of magnitude larger than λ in the quiescent stratosphere. Preliminary calculations showed that the photophoretic force is greatly reduced in real structures 10 when the walls/posts 22 are within a certain distance of the perimeters of the holes 20 because this proximity reduces the local temperature gradient near the holes 20. Our 1D models assume that all walls/posts 22 are spaced far enough from the holes 20 such that this 2D effect is insignificant. We assume that the pressure is uniform.

The net radiative heat absorbed by the photophoretically levitating macroscopic structure 10 is lost to the surroundings via air conduction from the surface air layer to the ambient atmosphere, which depends on the bulk conductivity of air. Heat is transferred from the photophoretically levitating macroscopic structure 10 to the surface air layer via conduction that is proportional to the accommodation coefficient of the surface. Heat is directly transferred between the two photophoretically active sheets 12 and 14 by structure conduction through the vertical walls/posts 22 (of the interlayer scaffold 21, where present), as well as the PAS support framework 82) and air. In the vertical regions where there are holes 20, there is also heat transfer between the surface air layers via conduction through the air and from air flows resulting from thermal transpiration.

To calculate the thrust on the photophoretically levitating macroscopic structure 10, we first solve the following system of conservation of energy equations for the following temperatures: T_{b} and Tₜ, the temperatures of the photophoretically active structure's bottom sheet 12 and top sheet 14, respectively. We then solve for T_{b,air} and T_{t,air}, the temperatures of the air one mean free path (MFP) above and below the photophoretically levitating macroscopic structure 10 (herein called “surface air layers”), respectively by assuming linear temperature gradients.

$${RF}_{b} + {RF}_{t} = ( {T}_{b} - T ) {h}_{b} + ( {T}_{t} - T ) {h}_{t} , \qquad ( 2 )$$

$$( ( {RF}_{b} - ( {T}_{b} - T ) {h}_{b} ) - ( {RF}_{t} - ( {T}_{t} - T ) {h}_{t} ) ) ( 1 - f ) = ( {T}_{b} - {T}_{t} ) ( {k}_{mat} \frac{w}{H} + {h}_{m} ( 1 - f - w ) ) + ( {T}_{b , air} - {T}_{t , air} ) ( {h}_{m , air} + {c}_{P} ( {T}_{b} - {T}_{t} ) ( {ρ}_{b} {v}_{b} - {ρ}_{t} {v}_{t} ) ) f \qquad ( 3 )$$

$$with$$

$${RF}_{b} = S ( t ) {ϵ}_{sb} ( A + ( 1 - {ϵ}_{st} ) ) + {ϵ}_{lb} σ ( {T}_{e}^{4} + {ϵ}_{lt} {T}_{t}^{4} - 2 {T}_{b}^{4} ) ,$$

$${RF}_{t} = S ( t ) {ϵ}_{st} ( 1 + A ( 1 - {ϵ}_{sb} ) ) + {ϵ}_{lt} σ ( ( 1 - {ϵ}_{lb} ) {T}_{e}^{4} + {ϵ}_{lb} {T}_{b}^{4} - 2 {T}_{t}^{4} ) ,$$

$${h}_{b} = {( {( \frac{{k}_{air}}{d} )}^{- 1} + {( \frac{Pv {α}_{b}}{T} )}^{- 1} )}^{- 1} ,$$

$${h}_{t} = {( {( \frac{{k}_{air}}{d} )}^{- 1} + {( \frac{Pv {α}_{t}}{T} )}^{- 1} )}^{- 1} ,$$

$${h}_{m} = {( {( \frac{{k}_{air}}{H} )}^{- 1} + {( \frac{Pv {α}_{b}}{T} )}^{- 1} + {( \frac{Pv {α}_{t}}{T} )}^{- 1} )}^{- 1} ,$$

$${h}_{m , air} = {( {( \frac{{k}_{air}}{H} )}^{- 1} + 2 {( \frac{Pv}{T} )}^{- 1} )}^{- 1} ,$$

The energy-conservation equations contain the heat transfer terms shown in FIG. 4. We compute the net radiative heat transfer to the top (bottom) sheet by multiplying its solar band emissivity ϵₛₜ (ϵ_{sb}) and longwave thermal-IR band emissivity ϵₗₜ (ϵ_{lb}) by the incident radiative solar flux and terrestrial thermal upwelling, respectively. Initial calculations showed a roughly 1% decrease in the thrust on the structure by accounting for a solar reflectivity of 0.05 typical of alumina. For simplicity, we assume the structure is not reflective.

All heat conduction terms have the general form kΔT/l, where k is a conductivity, ΔT is a temperature difference, and l is length scale describing ΔT. Any term describing conduction to or from either structural layer has a heat transfer coefficient, k/l, of the following form:

$${( {( \frac{{k}_{air}}{l} )}^{- 1} + {( \frac{Pva}{T} )}^{- 1} )}^{- 1} , \qquad ( 4 )$$

where kₐᵢᵣ is the bulk conductivity of air; υ is the mean molecular speed of air; and α is the accommodation coefficient of the corresponding horizontal layer. The term on the left dominates when l>>λ, and the other dominates when l<<λ; the total heat transfer term is equivalent to summing two thermal resistors in series. Both the solid vertical walls and the air in the adjacent hollow spaces conduct heat between the structural layers. The term describing conduction in the hollow spaces has the form of Equation 4 with an additional free-molecular term to account for the two surfaces' accommodation coefficients. Lastly, we use the same three terms to approximate heat conduction between the surface air layers in the vertical air columns with holes in the structure. We assume the surface air layers have accommodation coefficients of 1.

The thermal boundary layer conducts heat from the horizontal layers to the environment. We assume the same static boundary layer with thickness, d, on both sides of the structure; and we do not explicitly calculate convective heat loss. The real boundary layer between a lofted structure and its surroundings may be poorly defined and will vary with time, especially in turbulence. This is the largest limitation of our models. Computational fluid dynamics (CFD) could characterize the boundary layer as a function of time, in more than one dimension, and on both sides of the structure.

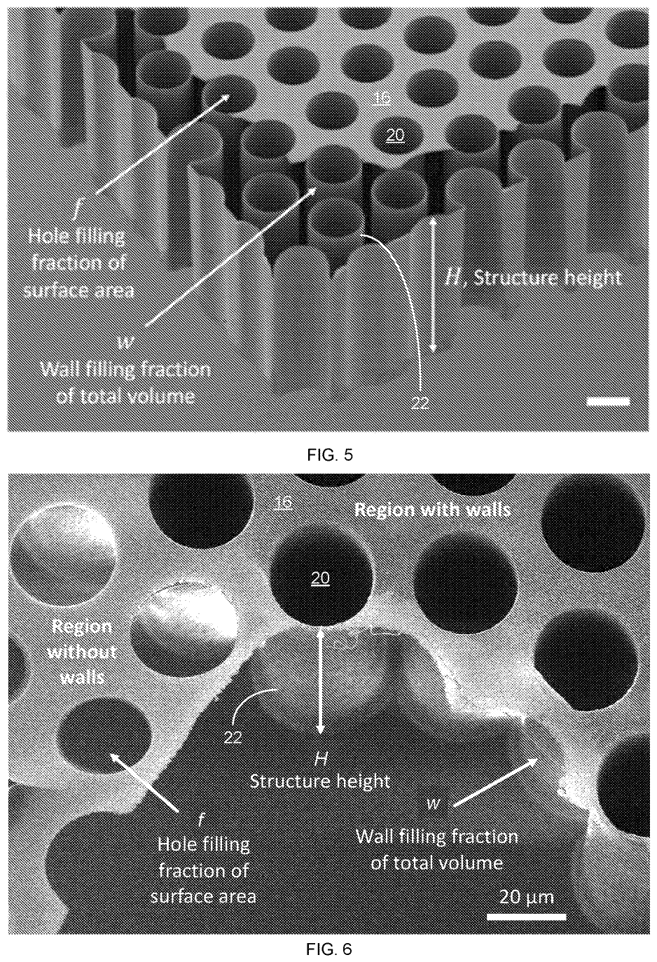

A scanning electron microscope (SEM) image of a structure labeled with key design parameters is shown in FIGS. 5 and 6. This structure varies from the previous model structure because the open cylindrical posts 22 of the interlayer scaffold 21 are concentric with the holes 20. Preliminary calculations showed the photophoretic force is greatly reduced in real structures when the posts 22 are within a certain distance of the hole perimeters because this proximity reduces the local temperature gradient near the holes 20. This sandwich structure can be fabricated by etching cylindrical channels into a silicon wafer, atomic layer depositing (ALD) 100 nm of alumina, then etching away the silicon. Posts 22 of height, H=125 μm, separate the top sheet 12 from the bottom sheet 14 and fill a fraction of the total volume, w=0.003, herein called the “wall filling fraction.” The hole filing fraction, f, is 0.4. Because the 1D models only calculate a vertical temperature profile, the shape and spacing of the walls are inconsequential. This modeling approximates real structures with periodically spaced walls that minimize horizontal temperature gradients. The top sheet 12 of the structure is etched away near the edges, showing the shape of the internal cylindrical channels. The posts 22 are spaced periodically to minimize horizontal temperature gradients; and the scale bar represents a length of 20 μm. If lofted in the stratosphere, an absorptive coating on the bottom surface would heat the bottom sheet 14 relative to the top sheet 12, creating a downward flow of air that thrusts the structure upward. We herein study structures on the order of 10 cm wide, which is a feasible fabrication range.

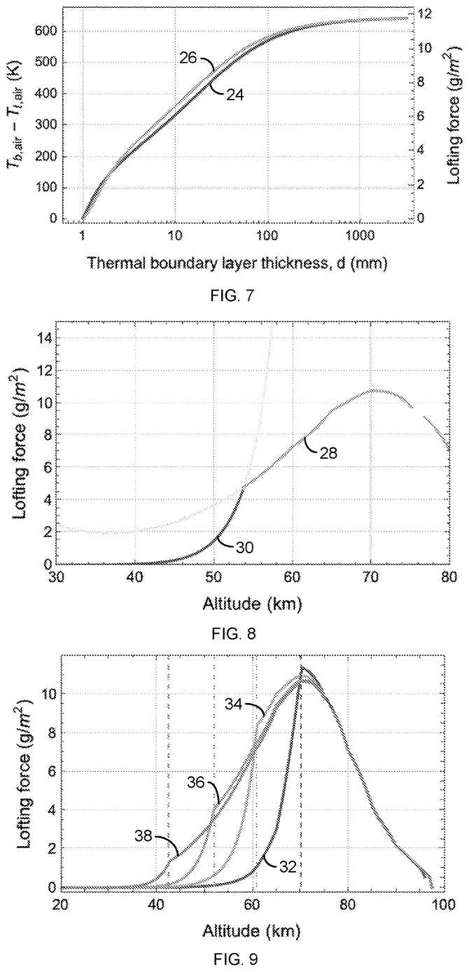

To calculate d, we first assumed the structure was a disk with an area density on the order of 1 g/m² falling at terminal velocity in the stratosphere. For a disk with diameter, D, on the order of cm, the standard thermal boundary layer equation gives d on the order of 1 m. This is unphysical because natural convection would limit the actual thermal boundary layer to a plume roughly the size of the structure's diameter. In fact, d<D only when D≥10 m. FIG. 7 shows plots of T_{b,air}−T_{t,air} 24 and the daily time-averaged lofting force 26 as the thermal boundary layer thickness, d, varies parametrically. The limit d→∞ maximizes the lofting force, and the lofting force approaches zero as d→λ due to decreasing T_{b,air}−T_{t,air}. Increasing d from 10 cm to infinity increases the time-averaged lofting force by 10%. Given the insensitivity of the lofting force to the macroscale boundary layer size, we set d=D=10 cm for all results herein. This assumption gives a 10% uncertainty in the lofting force and applies to the real macroscale structures that we wish to model.

The second largest limitation of our models is not accounting for horizontal temperature gradients within a structure. Such gradients exist due to hole and wall spacings, edge effects, and airflow around the structure. Our model best applies to (1) structures with hole and wall patterns that are small compared to their macroscopic size, (2) nonturbulent environments with minimal airflow around a structure, and (3) stationary structures.

As shown in FIG. 8, we developed two analytical models 28 and 30 that are valid in two different limits, H<<λ and H>>λ, respectively; we could not develop an analytical model for H~λ. In the H<<λ limit, we calculate the total thrust on the structure by treating the structure as infinitely thin and applying Equation 1, above. In the H>>λ limit, we calculate the air temperatures one mean free path (MFP) below and above the top and bottom sheets 12 and 14, respectfully, by assuming a linear vertical temperature gradient, (T_{b}−Tₜ)/H, between the two sheets 12 and 14. We then calculate the thrust on the top and bottom sheets 12 and 14 independently of each other by applying Equation 1 to both. We average the results to yield the total thrust on the structure. This model does not explicitly conserve mass between sides. The ratio of flow through the top sheet 12 to flow through the bottom sheet 14 is >90% for a structure with benchmark parameters in but can vary from unity by up to 25% across a range of parameters, as shown in FIG. 11, which includes plots for variations in each of the model's input parameters, all at peak daytime, where each plot assumes the benchmark parameters except for the noted variations. Specifically, FIG. 11 includes a plot 62 for the benchmark parameters (ϵ_{IR,t}=ϵ_{vis,b}=1, ϵv_{is,t}=ϵ_{IR,b}=0, f=0.47, w=0, H=125 μm, d=10 cm, and α_{b}=αₜ=0.6); a plot 64 where H is changed to 1 mm; a plot 66 where d is changed to 1 m; a plot 68 where d is changed to 1 cm; a plot 70 where f is changed to 0.9; a plot 72 where f is changed to 0.1; a plot 74 where α_{b}=αₜ=1; a plot 76 where α_{b}=αₜ=0.2; a plot 78 where w is changed to 10⁻³; and a plot 80 where ϵ_{vis,b}=ϵ_{IR,b}=ϵ_{IR,t}=1 and ϵ_{vis,t}=0. Together with the 10% uncertainty from the boundary layer, this gives our models a total uncertainty of roughly 30%.

### Results:

The boundary layer thickness, d, accounts for all non-radiative heat transfer between the structure and its surroundings. We ignore time-dependent feedback from levitating forces, the 3D turbulence profile of the flow around the structure, and horizontal temperature gradients. We simplified our modelling of the boundary layer to quickly calculate a general lofting force for quiescent environments. A more precise calculation requires computational fluid dynamics (CFD) modelling.

Results from the models are plotted in FIGS. 7-10. All plots assume a structure of atomic-layer-deposited (ALD) alumina with a thermal conductivity of 1.8 Wm⁻¹K⁻¹, αₜ=α_{b}=0.6, f=0.47, w=0, and a 10-cm disk diameter (set as d) unless otherwise specified.

The models for the limits, H<<λ and H>>λ, insufficiently describe the thrust when H~λ because the temperature gradient in the air between sides of the structure is poorly defined. Over the range of all parameters, the two 1D models converge when H~λ, or Kn(H)~1. Herein for any given structure, we only report the results of the H<<λ model for pressures below the intersection point and the results of the H>>λ model at higher pressures, as shown in FIG. 8, effectively taking the minimum of both models at a given Knudsen number.

FIG. 9 shows how the lofting force varies as a function of altitude for the following values of H: 1,000 μm 32; 300 μm 34; 100 μm 36; and 30 μm 38. In all cases, the lofting force from the H>>λ grows exponentially with decreasing pressure and that from the H<<λ model is insensitive to H. A structure can stably levitate if the time-averaged lofting force equals the gravitational force (the structure's weight) and if the time-averaged lofting force decreases with altitude. For instance, the structure described in FIG. 8 will levitate between 62 and 76 km, floating stably at 76 km, if its weight is 10 g/m².

The lofting force reaches a maximum of roughly 12 g/m² at 70 km when H is smaller than/at 70 km (about 1 mm). When H>1 mm, the lofting force peaks where H≈λ, which supports the general finding that mass flows are maximized in the transition regime (0.1<Kn(H)<10), usually around Kn(H)=1. However, the exact Knudsen number for maximum flow through a non-isothermal structure depends on the structure's geometry and the properties of the gas.

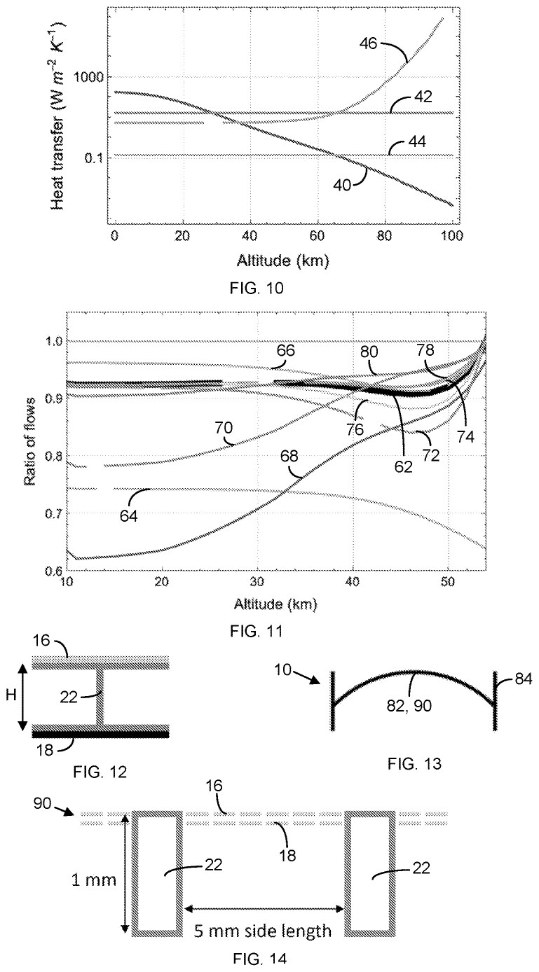

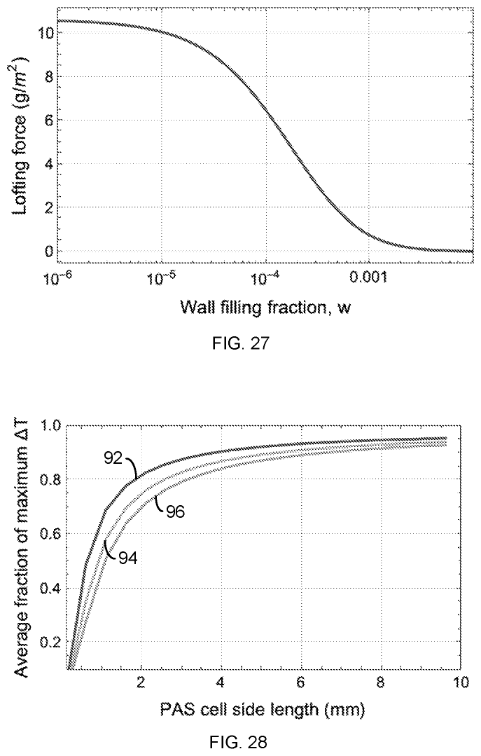

When H<1 mm, the maximum lofting force at 70 km is explained by the minimum total heat transfer between the structure's horizontal layers at that altitude FIG. 10 plots air conduction 40; structure conduction where the wall filling fraction, w=10⁻³ 42; structure conduction where the wall filling fraction, w=10⁻⁵ 44; and radiative transfer 46. When the wall filling fraction, w<3×10⁻⁴, air conduction 40 is the dominant mechanism in the stratosphere up to 60 km. The lofting force is insensitive to w<10⁻⁵ (FIG. 27) For comparison, Bargatin, et al., fabricated nanocardboard with a wall filling fraction, w, as low as 0.0018; and we have fabricated photophoretically levitating macroscopic structures with a wall filing fraction, w, as low as 2×10⁻⁵ in regions. An adequately stiff supporting structure could hold 100-nm-thick alumina membranes a distance, H, apart and without walls (w=0) across horizontal distances on the cm scale. Walls may only be needed to prevent the membranes from bending relative to each other and to provide adequate shear stiffness. Radiative heat transfer between sides is dominant in the mesosphere and above, while heat transfer due to thermal transpiration is a minor contribution at all altitudes above 10 km.

Across a range of parameters, we found that a hole filling fraction in the range of 0.3<f<0.5 maximizes the lofting force. FIG. 25 shows that the value, f=0.47, optimizes stratospheric lofting. This value is close to the theoretical value of f=50% calculated in Scandurra, M., “Enhanced Radiometric Forces,” arXiv: 0402011 [physics] (2004). Both models approach this value as H→λ. As f→0 and f→1, the lofting force approaches zero, as expected.

Optimizing the optical properties of the structure to maximize lofting is straightforward in the solar spectral band; the thrust is maximized with a transmissive and nonabsorptive top sheet 12 (ϵv_{is,t}=0) and an absorptive bottom sheet 14 (ϵ_{vis,b}=1). In the thermal band, the optimal parameters depend on the time of day. During the daytime, they are ϵ_{IR,b}=0 and ϵ_{IR,t}=1, corresponding to a perfect radiative cooling top sheet 12 and a perfect radiative warming bottom sheet 14. At night, they are ϵ_{IR,t}=ϵ_{IR,b}=1; a larger ϵ_{IR,b} increases the lofting force at night because terrestrial thermal upwelling is the only incident radiation. The optimal daytime emissivities maximize the time-averaged lofting force. A 10-cm-diameter disk structure at an altitude of 70 km with ϵv_{is,t}=ϵ_{IR,b}=0, ϵ_{IR,t}=ϵ_{vis,b}=1, H=125 μm, f=0.47, and w=0, herein called our “benchmark parameters,” has a time-averaged lofting force of 11 g/m², compared to 1 g/m² for a structure with emissivities optimized for nighttime levitation. To account for diurnal fluctuations, we weigh the solar flux by a positive sine wave with a period of 24 hours. We assume lofting at the equatorial equinox; averaging over the year reduces the time-averaged lofting force by 3%.

The lofting force generally increases as the accommodation coefficient of either top (αₜ) or bottom (α_{b}) surface decreases. FIG. 26 includes the following plots: benchmark plot 48 (αₜ=0.6, α_{b}=0.6); plot 50 (αₜ=1, a)=1); plot 52 (αₜ=0.2, α_{b}=0.2); plot 54 (αₜ=0.6, α_{b}=1); plot 56 (αₜ=1, α_{b}=0.6); plot 58 (αₜ=0.6, α_{b}=0.2); and plot 60 (αₜ=0.2, α_{b}=0.6). When air conduction is the dominant heat transfer mechanism between the sheets 12 and 14, the heat flux between surfaces is proportional to Equation 2. The flux is proportional to αₜ and α_{b} in the limit H<<1 and is unaffected by αₜ and α_{b} in the limit H>>λ. Various materials and surface treatment techniques have achieved a near 0.2. For all calculations herein, however, we assumed a benchmark value of αₜ=α_{b}=0.6, which is low but common for a range of materials in air. Assuming otherwise benchmark parameters at 70 km, setting αₜ=α_{b}=0.2 gives a time-averaged lofting force of 18 g/m², whereas setting αₜ=α_{b}=1 gives a force of 9 g/m². With H=125 μm, radiative heat transfer between the top and bottom sheets 12 and 14 equals heat conduction through air between the sheets 12 and 14 in the mid-stratosphere when α≈0.1. This value is improbably low for most materials, so air conduction will dominate heat transfer between sheets 12 and 14 in the stratosphere if w<3×10⁻⁴.

FIG. 28 is a plot of the change in temperature, ΔT, divided by the maximum value of ΔT averaged over the horizontal area of one hexagonal PAS cell of the photophoretically levitating macroscopic structure of FIG. 8 as a function of its side length and the thickness of the photophoretically active sheet, δ, where plots are included for δ=100 nm 92, δ=200 nm 94, and δ=300 nm 96. ΔT is set to zero at the edges of the cell. The y-axis of this plot may be interpreted as the ratio of the photophoretically levitating macroscopic structure's lofting force with a support structure to the lofting force of a photophoretically levitating macroscopic structure without a support structure.

### Practical Use:

Advantageously, the photophoretically levitating macroscopic structure 10, as shown in FIG. 30, can be designed to communicate (at least outwardly) and carry a payload. The ability to alter altitude and to fly horizontally are additional useful features, particularly when there is sufficient control to allow station-keeping. The components of the photophoretically levitating macroscopic structure 10 are (1) a photophoretically active structure (PAS) 90; (2) a PAS support framework 82; (3) a device superstructure 84 that prevents the photophoretically levitating macroscopic structure 10 from buckling or fracturing under forces encountered during transport, deployment, and flight, (4) hardware for communication, e.g., including an antenna 97; (5) hardware for attitude adjustment and navigation; and (6) the sensing payload including one more sensors 98 (e.g., an atmospheric sensor with a mass of a few milligrams), integrated circuitry 99 (with a mass of less than 1 mg), and power generation (e.g., a perovskite solar cell with a mass of a few milligrams) 100 and/or storage 101 (e.g., a supercapacitor with a mass of a few milligrams). For example, the hardware for communication can include a transceiver, such as a dipole antenna 97 roughly as wide as the photophoretically levitating macroscopic structure 10, which is about 3 cm in this exemplification but could have, e.g., a 10-cm width with additional cells, as shown and described elsewhere herein. The sensors, circuitry, and communications hardware are powered by an onboard energy storage device or solar cell (for powering the photophoretically levitating macroscopic structure during the day and charging the energy storage device for the night); and the sensors can be configured to measure, e.g., temperature, humidity, pressure, chemical composition, chemical reaction rates, wind speed, and/or radiation.

### Mechanical Design:

An exemplification of the photophoretically active structure (PAS) (FIGS. 12 and 21) is a sandwich of low-α and high-α surface coatings on two perforated 100-nm-thick alumina sheets spaced 125 μm apart. In the exemplification shown in FIG. 12, the photophoretically active structure includes both the interlayer scaffold 21 (here, in the shape of an I-beam with horizontally extending structures and a vertically extending wall or post 22) formed of ALD alumina and top and bottom coatings 12 and 14 on the respective top and bottom surfaces of the interlayer scaffold 21. The top photophoretically active sheet 12 includes a radiative-cooling coating 16 with low solar-band emissivity and high thermal-band absorptivity, while the bottom sheet 14 includes a coating 18 with high solar-band absorptivity and high thermal-band transmissivity. References to the thickness of the photophoretically active sheets 12 and 14 includes the thickness of the horizontally extending section of the interlayer scaffold 21 as well as the thickness of the photophoretically active coating 16/18 formed thereon. The interlayer scaffold 21 provides structural support for the photophoretically active compositions, which can be in the form of coatings 16 and 18. Another exemplification of a photophoretically active structure 90 with open cylindrical posts 22 separating the top and bottom PAS sheets 12 and 14.

The perforations (holes) 20 are a few hundred nanometers in diameter and account for f=47% of the area. Some perforations 20 are concentric with 100-nm thick cylindrical posts 22 (with an open interior) of an interlayer scaffold 21 that connect the two photophoretically active sheets 12 and 14, as shown in FIGS. 5 and 6. These posts 22 are spaced every 300 μm apart—close enough to prevent problematic relative bending of the photophoretically active sheets 12 and 14 and sparse enough to keep the wall filling fraction, w<10⁻⁵. The photophoretically active sheets 12 and 14 of the photophoretically active structure 90 are anchored to the PAS support framework 82, which is a honeycomb structure with a 1-cm hexagonal edge length made from rectangular alumina tubes that are 1-mm tall, 250-μm wide, and made of 250-nm-thick horizontal walls and 125-nm-thick vertical walls. In other exemplifications, the honeycomb structure of the PAS support framework 82 can have a 5-mm hexagonal edge length.

The photophoretically active structure (PAS) and PAS support framework can be fabricated simultaneously using ALD alumina on a silicon substrate. ALD alumina is an excellent material for lofted structures due to its low thermal conductivity (1.8 W/m-K) and low solar and thermal-band emissivities (both <0.1 for ~100 nm films).

The bottom coating 18 of the photophoretically active structure 90 is formed by coating the ALD-alumina interlayer scaffold 22 with a 200-nm thick multilayer of chromium and aluminum, which is highly solar absorptive (ϵ_{lb}=0.9) and infrared transmissive (ϵ_{lb}=0) with an areal density of 0.5 g/m². The best reported top surface coating is a 850-nm-thick solar transmissive (>0.99), IR absorptive (ϵₗₜ=0.9) multilayer coating weighing 2.1 g/m². Theoretically, much lighter (order 0.1 g/m²) coatings with comparable cooling efficacies may be fabricated. We assume a top surface coating with emissivities, ϵₗₜ=0.9 and ϵₛₜ=0, and weighing 1 g/m².

The top coating 16 provides radiative cooling with a low solar emissivity, E, and a high longwave e. The top coating 16 can be formed of, e.g., alumina, polymer, glass, nanoparticles, or metamaterials and can be 1-μm thick. A 1 g/m³ coating has an areal density of 1 g/m². The bottom coating 18 can be formed, e.g., of a chromium/alumina multilayer, carbon nanotubes, or carbon black and can have a broadband emissivity, ϵ~0.95, for a 300-nm thick coating and an areal density of 0.5 g/m².

At a tropical altitude of 70 km, our models predict that the photophoretically active structure 90 generates a time-averaged lofting force of 11 g/m². However, it does not account for heat flow through the PAS support framework 82, which will reduce the temperature difference across the photophoretically active structure 90 near the structural members of the device superstructure 84. We solved Poisson's equation for ΔT over a hexagonal domain with boundary condition ΔT=0 to simulate perfect vertical heat conduction within the PAS support framework. ΔT reaches 90% of its maximum at a horizontal distance about 500 μm from the walls or posts of the PAS support framework 82. A 4-mm-sided hexagonal PAS cell with 100-nm thick top and bottom Al₂O₃ layers loses 10% of its maximum lofting force to conduction through the PAS support framework 82, while a 10-mm-sided cell loses 4% (see FIG. 28).

Together, the photophoretically active structure 90 and its support framework 82 have an areal density of 2 g/m², with 1.5 g/m² from coatings and 0.5 g/m² from the PAS alumina. Accounting for the reductions to the lofting force of 7%, 5%, and 1% due to the area of the PAS support framework 82, the reduction in ΔT due to the support structure, and the reduction in ΔT due to the 300-μm spacing of the posts 22 of the interlayer scaffold 21 in the photophoretically active structure 90, respectively, the net time-averaged lofting force above the mass of the photophoretically active structure 90 and the PAS support framework 82 is 8 g/m².

Finite element analysis (FEA) shows 10 mm is a reasonable PAS cell-side length to withstand transportation, deployment, and flight without fracturing. Road transport and balloon launches can involve an acceleration force up to 2g, where g is gravitational acceleration. A 1 m/s wind blowing normal to the photophoretically levitating macroscopic structure 10 would create a Newtonian drag pressure of 0.3 Pa on the photophoretically active structure 90. If deployed from a balloon, 1 m/s is a liberal estimate for the wind load that a held structure may encounter as it becomes exposed to the open air. During flight, however, the photophoretically active structure 10 will need to lift the total weight of the photophoretically levitating macroscopic structure 10: roughly 10 g/m², 0.1 Pa, or 20 g on the alumina sandwich. We performed large deformation FEA on a 1-mm-sided square face sheet of 100-nm alumina fixed on all sides and a 1 mm-sided honeycomb support structure pattern fixed on one side and extrapolated the results to find reasonable sizes that would withstand the expected loads without buckling or fracturing. Assuming a fracture stress of 1 GPa, a Young's modulus of 170 GPa, and a Poisson's ratio of 0.21 for 100-nm-thick ALD alumina, a 10-mm sided PAS cell can withstand 0.4 Pa to within a factor of 3 before fracturing when rigidly fixed on all sides. This PAS cell could also withstand at least 10 times the critical buckling moment of the support structure before fracturing. Kim, et al., further explores the contributions of the face sheets and walls to the mechanical behavior of generalized nanocardboard plates; the photophoretically active structures 90 described herein include examples of such. Kim, J.-h., et al., “Ultralight and Ultra-stiff Nano-cardboard Panels: Mechanical Analysis, Characterization, and Design Principles,” 248 Acta Materialia 118782 (2023). In other embodiments, the PAS cells can have sides 5-mm in length.

The structural components of a practical levitating structure are shown in FIGS. 12, 14, 15, 17, 19, 20, and 22; and three possible attitude adjustment methods are shown in FIGS. 16-18. As shown in FIG. 21, the top and bottom sheets 12 and 14 of a photophoretically active structure (PAS) are separated by a distance H with no internal walls or posts 22 (w=0). The optimal PAS has no walls at all, which is what's shown in FIG. 21. This is ideal because any wall/post 22 acts as a thermal bridge between the top and bottom PAS sheets 12 and 14, which reduces the local temperature difference between them, and thus the local lofting force. However, you often need some kind of vertical wall/post 12 and 14 connecting the top and bottom sheets 12 and 14 because, otherwise, the top and bottom sheets 12 and 14 will bend and either break or crash into each other while lofting. We found that some form of wall 22 spaced every 300 μm prevents this problematic bending of the top and bottom sheets 12 and 14 but only reduces the average lofting force on the PAS by 1% due to thermal bridging.

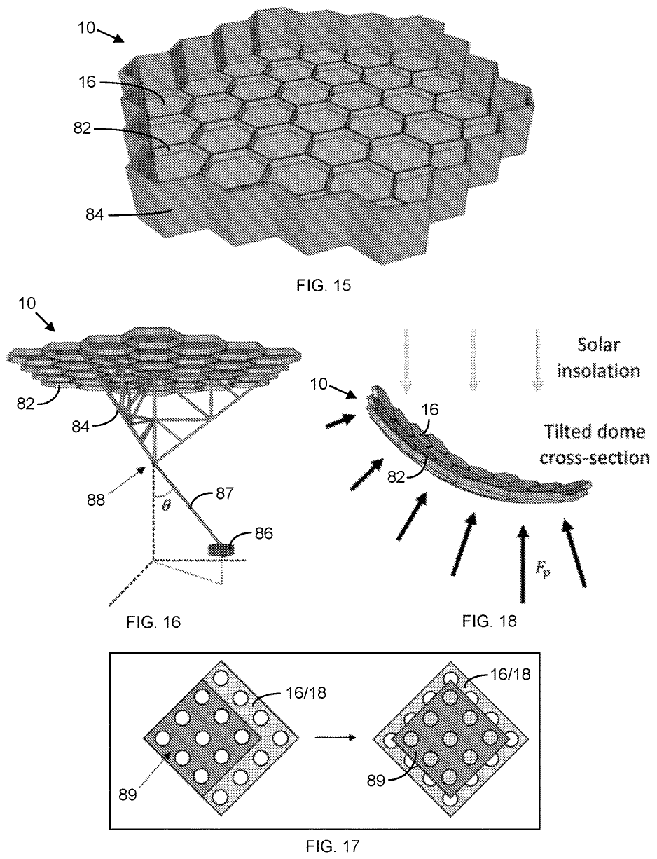

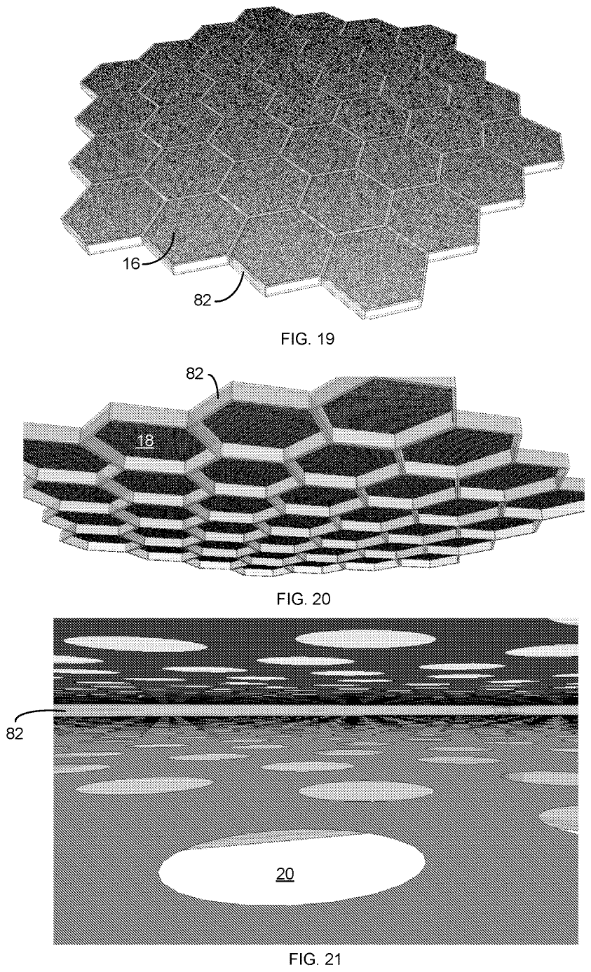

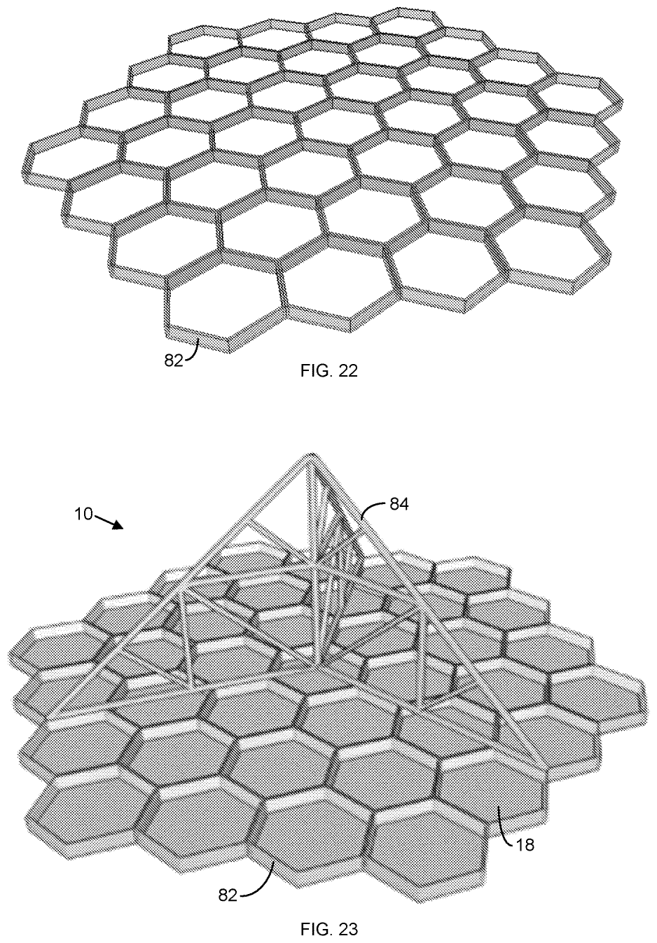

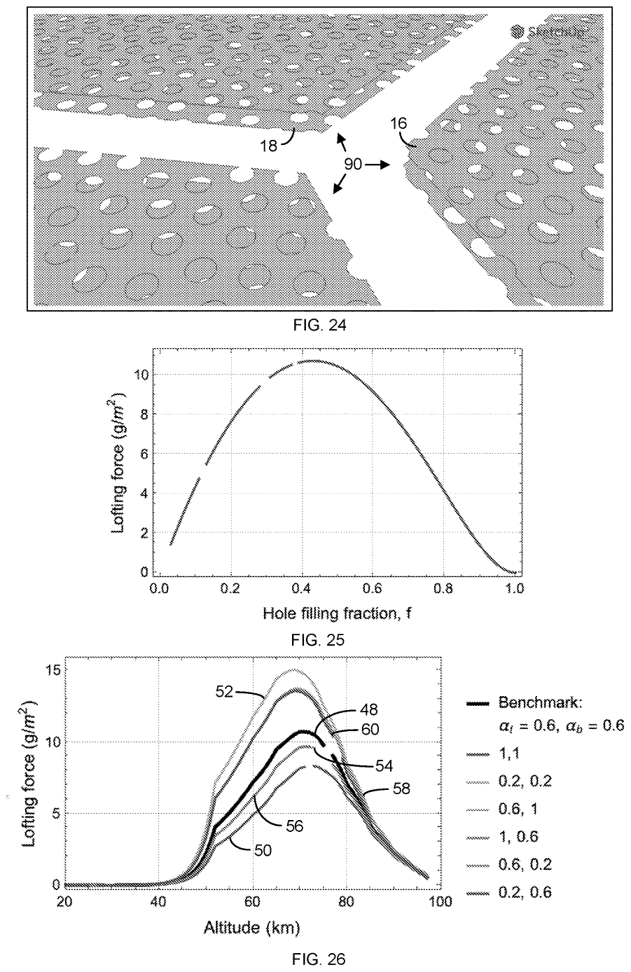

A vertical cross-section of a photophoretically active structure including coatings is shown in FIG. 12. Hexagonal cells of the photophoretically active sheets 12 and 14 supported by a honeycomb PAS support framework 82 are shown in FIGS. 14 and 15 along with a device superstructure 84 in the form of a ring along the perimeter of the honeycomb support framework 82, as shown in FIG. 15. A view from inside a hexagonal cell between the top and bottom PAS sheets 12 and 14 is provided in FIG. 21. The PAS cells are flush with the top of the honeycomb PAS support lattice 82. The vertical cross-section of the photophoretically active structure and support framework is illustrated in FIG. 14. The honeycomb lattice of the PAS support framework 82 without PAS cells is shown in FIG. 22. A bottom-up view of a device superstructure 82 in the form of a truss network is shown in FIG. 19.

A payload weight 86 attached to a rigid shaft 87 and angled with a MEMS actuator 88 secured to a pyramidal device superstructure 84 to adjust the tilt angle is shown in FIG. 16. In another exemplification, panels 89 with the same hole pattern as the photophoretically active structure can slide from an “open” position (at left) to block local thermal transpiration in a “closed” position (at right) using linear MEMS actuators, as shown in FIG. 17. In yet another exemplification, time-averaged insolation of the structure creates a restoring torque when the photophoretically active structure 90 and the PAS support framework 84, which are in the shape of a dome-shaped structure, tilt away from the horizontal, as shown in FIG. 18.

In our reference design, the device superstructure 84 is a space-filling truss that bonds to and rigidifies the PAS support framework 82. Space-filling trusses will generally provide more rigidity with less mass than could be achieved by stiffening a flat structure. With less mass than a thicker PAS support framework 82, the device superstructure 84 prevents failure of the PAS support framework 82 due to encountered loads, residual stresses, and fabrication defects. We designed and analyzed a device superstructure 84 in the form of an unoptimized truss with three 5-cm-long legs (FIG. 23) using SkyCiv software (from SkyCiv of Sydney, Australia). This 5-mg truss, made of carbon-fiber-reinforced plastic I-beams, supports roughly 10 times the maximum expected load on the entire structure. A 120-mg truss can support a 20-cm diameter disk with the same strength. Larger photophoretically levitating macroscopic structures with optimized trusses may support payloads of a few grams. In other exemplifications, the truss can have a mass of, e.g., 5 or 230 mg. Device superstructures can be 3D printed with a variety of materials, including reinforced plastics. Nanoscale direct laser writing (DLW) can create more-efficient space-filling trusses made of polymers, ceramics, or metals with features on the scale of 100 nm and densities of order 100 kg/m³.

In summary, our reference design is a 10-cm-diameter (i.e., the span across its greatest dimension) disk weighing 20 mg with a payload capacity of about 40 mg at 70 km. This design, however, is not optimal. It is a compromise between the goals of maximizing payload, specifying a design that can be fabricated with existing methods, and analytical simplicity.

Alternative designs may have advantages over this reference design. One alternative device superstructure 84 is a hexagonal ring along the outside of the smaller PAS support framework (FIG. 15), which can be formed, e.g., of alumina, another ceramic material, or a polymer formed via direct laser writing (DLW). Treating the full structure as a “supercell,” multiple supercells may be combined to form a larger honeycomb network. To further support any device superstructure design, the photophoretically active structure 90, the PAS support framework 82, and the device superstructure 84 can be fabricated with a dome-shaped profile (FIG. 18). Finite element analysis (FEA) showed a 200-μm wide (measured parallel to the span/diameter of the photophoretically levitating macroscopic structure 10), 20-μm tall (measured orthogonal to the span/diameter) half-spheroid structure that has 75% higher bending stiffness than a flat plate of the same thickness. To fabricate this dome, the photophoretically active structure 90, the PAS support framework 82, and device superstructure 84 can be constructed atop dome-shaped falsework. A shallow dome profile keeps both the horizontal component of the photophoretic force vector and any added weight insignificant relative to a flat disk.

A supporting ring functions as the device superstructure 84 in FIG. 15 and comprises a nanoscale truss support structure for the photophoretically active structure (PAS) 90, and the PAS support framework 82. The nanoscale truss support structure has a high strength-to-weight ratio and is fused to the photophoretically active sheets 12 and 14, as shown in FIG. 13. An alternative PAS support framework 82 is a supporting alumina layer with a honeycomb design.

### Communication:

Lofted devices without the ability to communicate are useless for atmospheric sensing unless they can be recovered. While recovery seems implausible, communication is not. Assume the minimum setup required for communication, as shown in FIG. 30, includes a transceiving radio antenna 97, a perovskite or organic solar cell 100, and any necessary processing and regulating integrated circuits (ICs) 99. Each component is much lighter than the 40-mg payload capacity of a 10-cm photophoretically levitating macroscopic structure. For instance, commercial amplifiers, microprocessors, and power regulation ICs on the order of 0.1 mg are readily available, and a 1-cm² solar cell of thickness 1 μm weighs roughly 0.2 mg. The antenna can be etched directly into the PAS support framework 82.

A photophoretically levitating macroscopic structure 10 with these components can communicate, e.g., with a receiver on the ground continuously during the day. A 3-cm² solar cell with 20% efficiency would source roughly 100 mW at peak daytime. A perfectly efficient 10-cm (3-GHz), 0-dB antenna at 70 km can send on the order of 1 Mb/s to a 1-m² aperture on the ground with a noise temperature 25 K and a 10-dB signal-to-noise ratio (SNR). A 10-W ground transmitter sends data to the photophoretically levitating macroscopic structure 10 with the same rate, gain, and SNR. Locating a lofted photophoretically levitating macroscopic structure 10 involves transmitting into a large solid angle; once its position is known, the data rate can be increased by focusing the transmitter.

Communication at night is facilitated by providing onboard energy storage 101. Allocating roughly half of this photophoretically levitating macroscopic structure's payload, 20 mg, to a supercapacitor with energy density 15 Wh/kg, the photophoretically levitating macroscopic structure 10 can communicate 15 kb/s with a signal-to-noise ratio (SNR)=10 dB to the ground at night.

### Attitude Adjustment:

Concentrating the payload in the bottom center of the photophoretically levitating macroscopic structure 10 will passively align the photophoretically levitating macroscopic structure 10 upward via gravity, and one can actively control the flight attitude to recover from turbulence, counteract drift, and navigate the photophoretically levitating macroscopic structure 10. First, a weight 86 (or the bulk of the payload) can be attached to a rigid shaft 87 hanging from the bottom center of the photophoretically levitating macroscopic structure 10, like a pendulum (see FIG. 16). A micro electromechanical system (MEMS) actuator 88 can change the hanging angle of the shaft 87 to tilt the main structure, as desired. Milligram-scale electromagnetic and piezoelectric linear MEMS actuators 88 can move hundreds of times their own weight and can be coupled with rotational MEMS stages to more effectively angle the shaft 87. The shaft 87 can be made out of direct-laser-writing (DLW) materials, discussed earlier. If L is the length of the shaft 87 (assumed to be weightless for simplicity) and θ is the angle between the shaft 87 and vertical, the torque per unit weight at the end of the shaft 87 is Lg sin θ, which is limited to below 1 Nm/kg for a shaft length that is the same as our structure size (greatest dimension across the PAS support framework) of 10 cm. A torque of this magnitude would restore a vertically aligned practical structure 10 to horizontal on the order of 1 second (i.e., the pendulum's natural period).

The second method for attitude adjustment actively blocks the flow through a particular area of the photophoretically active structure 90 to produce an orienting torque. On one side of the photophoretically active structure 90, sliding panels 89 that define the same hole pattern as the photophoretically active structure 90 can be attached (see FIG. 17). The panels 89 can slide to “open” or “close” the holes in the structure using linear electromagnetic or piezoelectric MEMS actuators. If spaced symmetrically around the structure photophoretically levitating macroscopic structure 10, the MEMS actuators will impart no significant gravitational torque to the photophoretically levitating macroscopic structure 10. In one exemplification, many discrete panels line a thin ring along the perimeter of our photophoretically levitating macroscopic structure 10. Assuming the orienting force is concentrated on the edge of the photophoretically levitating macroscopic structure 10, the disk has radius, r, and the panels 89 have areal density, D; the torque on the photophoretically levitating macroscopic structure 10 per unit weight of the panels 89 is up to rFₚ/D. One such panel 89 moves to block the airflow near a point on the perimeter of the photophoretically levitating macroscopic structure 10. If D=2 g/m² (the same areal density of our optimal photophoretically active structure 90), r=5 cm, and Fₚ=3.6 g/m², the torque per weight is 0.9 Nm/kg, giving a reorientation time roughly equal to that of a weight on a stick.

Alternatively, the panels 89 can be displaced by creating/manipulating local temperature gradients. A domed structural profile does this passively with stronger lofting forces on areas with more solar insolation (see FIG. 18). Other active approaches include resistive heating and programmable self-shape arrays that change local emissivities. A dome-shaped structural profile can achieve this passively via the angle of the photophoretically levitating macroscopic structure 10 with respect to the sun, with stronger lofting forces on areas with more solar insolation (FIG. 18). If the structure 10 tips from the horizontal, inhomogeneous insolation produces a restoring torque on the photophoretically levitating macroscopic structure 10 (see FIG. 18). Active approaches to changing local temperatures include resistive heating and programmable self-shape arrays or metamaterials that change the local emissivity of the surface. The use of metamaterial coatings and substructures may offer higher torques per weight than other attitude adjustment techniques, or even allow for remote positioning of the photophoretically levitating macroscopic structure 10 via photonic self-stabilization.

### Vertical and Horizontal Motion:

To calculate a structure's altitude over time, one can iteratively solve the balance among the lofting, gravitational, and Stokes drag forces. A photophoretically levitating macroscopic structure 10 with a total areal density of 11 g/m² will levitate at 70 km indefinitely, bobbing up and down within a vertical diurnal range of 15 km.

Throughout the year at suitable coordinates, one may be able to “fly” these photophoretically levitating macroscopic structures 10 horizontally with sufficient speed to overcome prevailing winds and maintain a roughly constant position over the ground. Among other uses, such a station-keeping capability would allow communication with a single station on the ground. A tilted plate will fly driven by the small horizontal force vector that is residual between the downward gravitational force and the levitating force normal to the plate. The drag on the photophoretically levitating macroscopic structure 10 is a determined by the Reynold's number, Re, which for horizontal motion is strongly dependent on small tilt angles about 0°. Microscale structures, such as those discussed by Keith, are small enough to be clearly in the Stokes flow regime (Re≤1) for any tilt angle in a quiescent environment, such as the stratosphere. Structures with horizontal dimensions on the order of 10 cm, however, enter the transition flow regime (1≤Re≤1000) when their speed relative to ambient winds is greater than roughly 0.5 m/s or the tilt angle is greater than roughly 1°. While transitional flow may be common, turbulent flow (Re≥1000) will be rare. Turbulent patches are highly intermittent in the stratosphere and mesosphere; tracer particles in the stratosphere encounter a new stratospheric turbulent patch on average once daily. These patches are of order 50 m tall to 100 m wide, small enough for photophoretically levitating macroscopic structure s 10 with active attitude adjustment to plausibly navigate. Our calculations assume Stokes flow for both horizontal and vertical motion.

In the Stokes flow regime, the horizontal drift speed is independent of small tilt angles because the horizontal components of the lofting force and Stokes drag force are both proportional to the inclination. However, for slightly tilted plates, which have vertical cross sections with high aspect ratios, the Stokes drag coefficient is not well known. The formulae for drag on thin plates given by the aforementioned Keith and Cortez, et al., references can be used to approximate the drag; these references show that a 10-cm-diameter structure has a horizontal velocity that increases exponentially with altitude, ranging from order 1 cm/s at 20 km to 1 m/s at 50 km to 10 m/s at 70 km. There are typically some stratospheric and mesospheric regions with average total wind speeds below 1 m/s, so station keeping using horizontal motion may be feasible at some times.

Alternately, photophoretically levitating macroscopic structures 10 may station-keep adjusting float altitude to take advantage of wind shear, as is done for stratospheric balloons. To control altitude within an operational range, a photophoretically levitating macroscopic structure 10 can tilt sufficiently to reduce lofting force so that adjustment of average tilt angle will allow limited altitude control.

Alternatively, photophoretically levitating macroscopic structures 10 may station-keep by adjusting float altitude to take advantage of wind shear, as is done for stratospheric balloons. To control altitude within an operational range, a photophoretically levitating macroscopic structure 10 can tilt sufficiently to reduce lofting force so that adjustment of average tilt angle would allow limited altitude control. To decrease altitude, the photophoretically levitating macroscopic structure 10 can tilt to reduce its net upward force and continuously rotate to perform a controlled spiral dive. If a faster descent is needed, aligning the photophoretically levitating macroscopic structure 10 vertically will cause it to stall and fall rapidly until the desired altitude is reached, at which horizontal alignment can be restored. Further, to increase altitude beyond its stable levitating range, the photophoretically levitating macroscopic structure 10 can release a small sacrificial payload. Alternatively, remotely illuminating the photophoretically levitating macroscopic structure 10 with a laser from the ground or nearby balloon can temporarily increase the lofting force.

### Deployment, Communication, and Exposure in the Stratosphere:

To transport photophoretically levitating macroscopic structures 10 to the stratosphere and mesosphere, the photophoretically levitating macroscopic structures 10 can be connected to a larger frame that, if made of silicon, can be fabricated concurrently with the photophoretically levitating macroscopic structure 10. This frame would ensure ease of handling while only being rigidly connected to the photophoretically levitating macroscopic structure 10 at a few junctions. The junctions can be piezoelectrically controlled latches or fused wax joints that fail upon heating. When the junctions open, a burst of air can push the structures into the open atmosphere. If the turbulent forces encountered in aircraft deployment easily break the structures; deployment via balloons (e.g., weather balloons, which can easily lift 1 kg to the stratosphere) or a sounding rocket can provide a more feasible alternative approach.

Once deployed in the stratosphere and mesosphere, lofted photophoretically levitating macroscopic structures 10 endure increased exposure to UV radiation, sulfate aerosols, and ozone. Inert structural components, such as the alumina interlayer scaffold 21 and the PAS support framework 82, will be largely unaffected. However, possible top surface coatings and DLW materials, such as organic polymers and metals, can be treated to prevent degradation. Sulfate aerosol condensation may accelerate polymer degradation, damage electrical components, and block holes in the photophoretically active structure 90 over time.

### Exemplary Applications:

Integrated circuits (ICs) with a mass, e.g., of 1 mg or less, and capable of sourcing their own power and performing wireless atmospheric sensing can be easily integrated into the levitating structures 10, discussed above. Nanoscale sensors for temperature, humidity, and chemical composition, among other properties, are good candidates for lofting. As discussed earlier, a 1-cm² solar cell would generate 20 mW in peak sunlight. This power generation could easily power “the world's smallest computer,” a 0.04 mm³, 16 nW microprocessor weighing on the order of 0.1 mg. Less-complex ICs with more specific uses can weigh hundreds of nanograms and provide vast opportunity for microelectronic systems in the upper atmosphere. Since settling velocities are on the order of kilometers per day, microelectronic systems could record vertical profiles of stratospheric properties at precise altitudes with high frequency.

Arrays of lofted structures 10 could transmit or relay data. Daytime data rates can be high, a thousand structures that are slightly larger than the reference design described herein could have daytime data rates comparable to the 10 Gb/s per satellite for current low-earth orbit (LEO) satellite constellations.

Photophoretically levitating macroscopic structures 10 can also be deployed in atmospheres surrounding other planets. At the Martian tropopause (40 km altitude), for instance, the time-averaged lofting force on a PAS with H=250 μm, f=0.32, ϵv_{is,t}=ϵ_{IR,b}=0, ϵ_{IR,t}=ϵ_{vis,b}=1, and otherwise matching the reference parameters is 12 g/m², roughly equal to the lofting force in Earth's mesosphere, assuming an ambient temperature of 156 K and an ambient pressure of 10 Pa. The lofting force is much weaker at Mars's surface, and dust storms might destroy practical structures deployed there.

Additional examples consistent with the present teachings are set out in the following numbered clauses:
1. A photophoretically levitating macroscopic structure, comprising:
   a photophoretically active structure (PAS), comprising at least one top sheet and at least one bottom sheet, wherein the bottom sheet has greater solar-radiation absorptivity than the top sheet, wherein each sheet defines a pattern of holes through which gas can flow, wherein the sheets are separated by a gap that defines an open volume extending across a plurality of holes in each sheet;
   a PAS support framework in which or on which the photophoretically active structure is mounted; and
   a device superstructure mounted to and spanning the PAS support framework to increase the rigidity of the photophoretically levitating macroscopic structure.
2. The photophoretically levitating macroscopic structure of clause 1, wherein the top sheet has greater solar-radiation transmissivity than the bottom sheet.
3. The photophoretically levitating macroscopic structure of clause 1 or 2, wherein the top sheet has greater thermal emissivity and greater solar transparency than the bottom sheet.
4. The photophoretically levitating macroscopic structure of any of clauses 1-3, wherein the bottom sheet comprises (a) a base layer that defines the holes and (b) a material deposited on the base layer that has a greater solar-radiation absorptivity than the base layer.
5. The photophoretically levitating macroscopic structure of any of clauses 1-4, wherein the sheets of the photophoretically active structure comprise aluminum oxide.
6. The photophoretically levitating macroscopic structure of clauses 4 and 5, wherein the base layer of the bottom sheet comprises the aluminum oxide and the material deposited thereon is selected from carbon nanotubes, graphene, carbon black, chromium, aluminum oxide, and a multilayer coating comprising a plurality of these materials.
7. The photophoretically levitating macroscopic structure of any of clauses 1-6, wherein the top sheet comprises a base layer that defines the holes and a material deposited on the base layer that provides a radiative cooling capability, and wherein the deposited material is selected from modified alumina, a glass, an organic polymer, a metamaterial structure, and a multilayer coating comprising a plurality of these materials.
8. The photophoretically levitating macroscopic structure of any of clauses 1-7, wherein the sheets of the photophoretically active structure each have a thickness of 20-200 nm.
9. The photophoretically levitating macroscopic structure of any of clauses 1-8, wherein the PAS support framework has a cellular structure with a plurality of connected cells and with a section of the top sheet and a section of the bottom sheet contained in each cell.
10. The photophoretically levitating macroscopic structure of clause 9, wherein the cells of the PAS support framework are honeycomb structures with hexagonal cells and hexagonal sections of the sheets of the photophoretically active structure in the cells.
11. The photophoretically levitating macroscopic structure of clause 9 or 10, wherein each cell has a span in a range from 1 mm to 2 cm parallel to the sheets across the cell.
12. The photophoretically levitating macroscopic structure of any of clauses 9-11, wherein the gap between the top and bottom sheets extends continuously across the plurality of holes is in a range from 1 mm to 2 cm in each cell.
13. The photophoretically levitating macroscopic structure of any of clauses 1-12, wherein the top sheet is separated across the gap from the bottom sheet by a height distance, H, of 5 to 500 μm.
14. The photophoretically levitating macroscopic structure of any of clauses 1-13, wherein the top sheet is transparent to solar radiation.
15. The photophoretically levitating macroscopic structure of clause 14, wherein the bottom sheet is opaque to solar radiation.
16. The photophoretically levitating macroscopic structure of any of clauses 1-15, wherein the device superstructure extends for at least 2 cm along dimensions parallel to the sheets.
17. The photophoretically levitating macroscopic structure of any of clauses 1-16, wherein the device superstructure comprises a network of interconnected trusses connected to a side of the PAS support framework facing the bottom sheet of the photophoretically active structure.
18. The photophoretically levitating macroscopic structure of any of clauses 1-17, wherein a minority of the holes are substantially circular and concentric with vertical cylindrical posts that span a height distance, H, between the sheets of the photophoretically active structure and that connect to both of the sheets.
19. The photophoretically levitating macroscopic structure of clause 18, wherein the posts comprise aluminum oxide and have a thickness substantially equal to that of the sheets of the photophoretically active structure and are spaced between 50 and 500 μm apart.
20. The photophoretically levitating macroscopic structure of clause 18, wherein the substantially circular holes have a diameter no greater than 80 μm.
21. The photophoretically levitating macroscopic structure of any of clauses 1-20, wherein the holes are spaced less than 1 mm apart from their nearest neighboring holes.
22. The photophoretically levitating macroscopic structure of any of clauses 1-21, wherein each sheet has a hole filling fraction, f, in a range from 0.3 to 0.7.
23. The photophoretically levitating macroscopic structure of any of clauses 1-22, wherein the gap between the sheets in the photophoretically active structure has a wall filling fraction, w, of less than 0.001.
24. The photophoretically levitating macroscopic structure of any of clauses 1-23, wherein the PAS support framework has a domed-disk shape.
25. The photophoretically levitating macroscopic structure of any of clauses 1-24, further comprising an energy storage device and a solar cell mounted to at least one of the PAS support framework and the photophoretically active structure.
26. The photophoretically levitating macroscopic structure of clause 25, further comprising:
   a transceiver powered by the energy storage device or solar cell; and
   a sensor configured to measure at least one of temperature, humidity, pressure, chemical composition, chemical reaction rates, wind speed, and radiation.
27. The photophoretically levitating macroscopic structure of any of clauses 1-26, further comprising a weighted shaft pivotably mounted to the superstructural scaffold, extending outwardly away from the bottom sheet, and configured to adjust the attitude of the photophoretically levitating macroscopic structure during flight.
28. The photophoretically levitating macroscopic structure of any of clauses 1-26, further comprising at least one sliding plate configured to open and close at least some of the holes when displaced across at least one of the top sheet and the bottom sheet and configured to thereby adjust the attitude of the photophoretically levitating macroscopic structure during flight.
29. A method for photophoretically levitating a macroscopic structure, comprising:
   delivering the macroscopic structure of any of clauses 1-28 to a layer in an atmosphere about a celestial body;
   preferentially receiving solar radiation on the bottom sheet to heat the bottom sheet to a higher temperature than the top sheet;
   transferring heat from the bottom sheet to air from the atmosphere to warm the air below the photophoretically active structure to a higher temperature than the air above the photophoretically active structure;
   via thermal transpiration, generating flow of air from above the top sheet, through holes in the top sheet, into the gap, and out holes in the bottom sheet; and
   levitating the macroscopic structure in the atmospheric layer via upward force generated by the differential in the heat transfer and the thermal transpiration.
30. The method of clause 29, wherein the celestial body is earth, and wherein the layer in the atmosphere is the stratosphere.
31. The method of clause 29 or 30, using the photophoretically levitating macroscopic structure of clause 26, wherein the additional components have a mass of at least 10 mg.
32. The method of any of clauses 29-31, further comprising measuring at least one of the following properties in the atmosphere: temperature, humidity, pressure, wind speed, radiometry, and chemical composition.
33. The method of clause 32, further comprising wirelessly communicating the measured property from the photophoretically levitating a macroscopic structure to a remote receiver.
34. The method of clause 29, wherein the macroscopic structure is levitated in the atmosphere at a target flight attitude, wherein at least some of the holes are substantially circular with a diameter less than the mean free path of gas molecules surrounding the macroscopic structure at the target flight altitude.
35. The method of any of clauses 29-34, using the photophoretically levitating macroscopic structure of clause 27, further comprising adjusting the attitude of the photophoretically levitating macroscopic structure by displacing the weighted shaft about its pivotable mount.
36 The method of any of clauses 29-34, using the photophoretically levitating macroscopic structure of clause 26, further comprising adjusting the attitude of the photophoretically levitating macroscopic structure by displacing the sliding plate to cover or uncover some of the holes.
37. The method of any of clauses 29-34, further comprising adjusting the attitude of the photophoretically levitating macroscopic structure by creating a temperature differential across the bottom sheet.
38. The method of any of clauses 35-37, wherein the attitude adjustment is used to control horizontal and vertical motion of the photophoretically levitating macroscopic structure.
39. The method of clause 29, wherein the macroscopic structure is levitated in the atmosphere at a target flight attitude, wherein the top sheet is separated across the gap from the bottom sheet by a height distance, H, of ⅓ λ≤H<3), and wherein the holes in the top and bottom sheets have a width less than λ, where λ is the mean free path of gas molecules surrounding the macroscopic structure at the target flight altitude, and where the width is measured across the hole.

In describing embodiments, herein, specific terminology is used for the sake of clarity. For the purpose of description, specific terms are intended to at least include technical and functional equivalents that operate in a similar manner to accomplish a similar result. Additionally, in some instances where a particular embodiment includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof or within a range of the specified parameter up to or down to any of the variations specified above (e.g., for a specified parameter of 100 and a variation of 1/100^{th}, the value of the parameter may be in a range from 0.99 to 1.01), unless otherwise specified. Further still, where methods are recited and where steps/stages are recited in a particular order—with or without sequenced prefacing characters added for ease of reference—the steps/stages are not to be interpreted as being temporally limited to the order in which they are recited unless otherwise specified or implied by the terms and phrasing.

While this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention.

What is claimed is:

1. A photophoretically levitating macroscopic structure, comprising:
a photophoretically active structure (PAS), comprising at least one top sheet and at least one bottom sheet, wherein the bottom sheet has greater solar-radiation absorptivity than the top sheet, wherein each sheet defines a pattern of holes through which gas can flow, wherein the sheets are separated by a gap that defines an open volume extending across a plurality of holes in each sheet;
a PAS support framework in which or on which the photophoretically active structure is mounted; and
a device superstructure mounted to and spanning the PAS support framework to increase the rigidity of the photophoretically levitating macroscopic structure.

2. The photophoretically levitating macroscopic structure of claim 1, wherein the top sheet has greater solar-radiation transmissivity than the bottom sheet.

3. The photophoretically levitating macroscopic structure of claim 1, wherein the top sheet has greater thermal emissivity and greater solar transparency than the bottom sheet.

4. The photophoretically levitating macroscopic structure of claim 1, wherein the bottom sheet comprises (a) a base layer that defines the holes and (b) a material deposited on the base layer that has a greater solar-radiation absorptivity than the base layer.

5. The photophoretically levitating macroscopic structure of claim 1, wherein the sheets of the photophoretically active structure comprise aluminum oxide.

6. The photophoretically levitating macroscopic structure of claim 4, wherein the sheets of the photophoretically active structure comprise aluminum oxide, and wherein the base layer of the bottom sheet comprises the aluminum oxide and the material deposited thereon is selected from carbon nanotubes, graphene, carbon black, chromium, aluminum oxide, and a multilayer coating comprising a plurality of these materials.

7. The photophoretically levitating macroscopic structure of claim 1, wherein the top sheet comprises a base layer that defines the holes and a material deposited on the base layer that provides a radiative cooling capability, and wherein the deposited material is selected from modified alumina, a glass, an organic polymer, a metamaterial structure, and a multilayer coating comprising a plurality of these materials.

8. The photophoretically levitating macroscopic structure of claim 1, wherein the sheets of the photophoretically active structure each have a thickness of 20-200 nm.

9. The photophoretically levitating macroscopic structure of claim 1, wherein the PAS support framework has a cellular structure with a plurality of connected cells and with a section of the top sheet and a section of the bottom sheet contained in each cell.

10. The photophoretically levitating macroscopic structure of claim 9, wherein the cells of the PAS support framework are honeycomb structures with hexagonal cells and hexagonal sections of the sheets of the photophoretically active structure in the cells.

11. The photophoretically levitating macroscopic structure of claim 9, wherein each cell has a span in a range from 1 mm to 2 cm parallel to the sheets across the cell.

12. The photophoretically levitating macroscopic structure of claim 9, wherein the gap between the top and bottom sheets extends continuously across the plurality of holes is in a range from 1 mm to 2 cm in each cell.

13. The photophoretically levitating macroscopic structure of claim 1, wherein the top sheet is separated across the gap from the bottom sheet by a height distance, H, of 5 to 500 μm.

14. The photophoretically levitating macroscopic structure of claim 1, wherein the top sheet is transparent to solar radiation.

15. The photophoretically levitating macroscopic structure of claim 14, wherein the bottom sheet is opaque to solar radiation.

16. The photophoretically levitating macroscopic structure of claim 1, wherein the devices superstructure extends for at least 2 cm along dimensions parallel to the sheets.

17. The photophoretically levitating macroscopic structure of claim 1, wherein the device superstructure comprises a network of interconnected trusses connected to a side of the PAS support framework facing the bottom sheet of the photophoretically active structure.

18. The photophoretically levitating macroscopic structure of claim 1, wherein a minority of the holes are substantially circular and concentric with vertical cylindrical posts that span a height distance, H, between the sheets of the photophoretically active structure and that connect to both of the sheets.

19. The photophoretically levitating macroscopic structure of claim 18, wherein the posts comprise aluminum oxide and have a thickness substantially equal to that of the sheets of the photophoretically active structure and are spaced between 50 and 500 μm apart.

20. The photophoretically levitating macroscopic structure of claim 18, wherein the substantially circular holes have a diameter no greater than 80 μm.

21. The photophoretically levitating macroscopic structure of claim 1, wherein the holes are spaced less than 1 mm apart from their nearest neighboring holes.

22. The photophoretically levitating macroscopic structure of claim 1, wherein each sheet has a hole filling fraction, f, in a range from 0.3 to 0.7.

23. The photophoretically levitating macroscopic structure of claim 1, wherein the gap between the sheets in the photophoretically active structure has a wall filling fraction, w, of less than 0.001.

24. The photophoretically levitating macroscopic structure of claim 1, wherein the PAS support framework has a domed-disk shape.

25. The photophoretically levitating macroscopic structure of claim 1, further comprising an energy storage device and a solar cell mounted to at least one of the PAS support framework and the photophoretically active structure.

26. The photophoretically levitating macroscopic structure of claim 25, further comprising:
a transceiver powered by the energy storage device or solar cell; and
a sensor configured to measure at least one of temperature, humidity, pressure, chemical composition, chemical reaction rates, wind speed, and radiation.

27. The photophoretically levitating macroscopic structure of claim 1, further comprising a weighted shaft pivotably mounted to the superstructural scaffold, extending outwardly away from the bottom sheet, and configured to adjust the attitude of the photophoretically levitating macroscopic structure during flight.

28. The photophoretically levitating macroscopic structure of claim 1, further comprising at least one sliding plate configured to open and close at least some of the holes when displaced across at least one of the top sheet and the bottom sheet and configured to thereby adjust the attitude of the photophoretically levitating macroscopic structure during flight.

29. A method for photophoretically levitating a macroscopic structure, comprising:
delivering the macroscopic structure of claim 1 to a layer in an atmosphere about a celestial body;
preferentially receiving solar radiation on the bottom sheet to heat the bottom sheet to a higher temperature than the top sheet;
transferring heat from the bottom sheet to air from the atmosphere to warm the air below the photophoretically active structure to a higher temperature than the air above the photophoretically active structure;
via thermal transpiration, generating flow of air from above the top sheet, through holes in the top sheet, into the gap, and out holes in the bottom sheet; and
levitating the macroscopic structure in the atmospheric layer via upward force generated by the differential in the heat transfer and the thermal transpiration.

30. The method of claim 29, wherein the celestial body is earth, and wherein the layer in the atmosphere is the stratosphere.

31. The method of claim 29, using the photophoretically levitating macroscopic structure of claim 26, wherein the additional components have a mass of at least 10 mg.

32. The method of claim 29, further comprising measuring at least one of the following properties in the atmosphere: temperature, humidity, pressure, wind speed, radiometry, and chemical composition.

33. The method of claim 32, further comprising wirelessly communicating the measured property from the photophoretically levitating a macroscopic structure to a remote receiver.

34. The method of claim 29, wherein the macroscopic structure is levitated in the atmosphere at a target flight attitude, wherein at least some of the holes are substantially circular with a diameter less than the mean free path of gas molecules surrounding the macroscopic structure at the target flight altitude.

35. The method of claim 29, using the photophoretically levitating macroscopic structure of claim 27, further comprising adjusting the attitude of the photophoretically levitating macroscopic structure by displacing the weighted shaft about its pivotable mount.

36. The method of claim 29, using the photophoretically levitating macroscopic structure of claim 26, further comprising adjusting the attitude of the photophoretically levitating macroscopic structure by displacing the sliding plate to cover or uncover some of the holes.

37. The method of claim 29, further comprising adjusting the attitude of the photophoretically levitating macroscopic structure by creating a temperature differential across the bottom sheet.

38. The method of claim 35, wherein the attitude adjustment is used to control horizontal and vertical motion of the photophoretically levitating macroscopic structure.

39. The method of claim 29, wherein the macroscopic structure is levitated in the atmosphere at a target flight attitude, wherein the top sheet is separated across the gap from the bottom sheet by a height distance, H, of ⅓ λ<H<3λ, and wherein the holes in the top and bottom sheets have a width less than λ, where λ is the mean free path of gas molecules surrounding the macroscopic structure at the target flight altitude, and where the width is measured across the hole.
